(19) United States
(12) Patent Application Publication
(10) Pub. No.: US 2002/0078226 A1
(43) Pub. Date: Jun. 20, 2002

(54) Datagram transmission device

(76) Inventors: Kei Kato, Chiba (JP); Takahiro Yamashita, Chiba (JP)

Correspondence Address: VENABLE, BAETJER, HOWARD AND CIVILETTI, LLP, P.O. BOX 34385, WASHINGTON, DC, 20043-9998, US

(21) Appl. No.: 10/005,818

(22) Filed: Dec. 7, 2001

(30) Foreign Application Priority Data
Dec. 15, 2000 (JP) 381437/2000
Mar. 1, 2001 (JP) 056989/2001

(51) Int. Cl. G06F 15/16

(52) U.S. Cl. 709/236; 709/203

(57) ABSTRACT

Datagram transmission device that executes route searching and other searching at high speed. Information used for transmission control is read from a received datagram and the information that are thus read are used to generate an identification key. Next, a transmission control rule corresponding to the selected key is selected from a transmission control rule list. The datagram transmission device controls transmission of the datagram in accordance with the selected transmission control rule. Since the transmission control rule is selected from a list using an identification key, determination of the content of control can be performed in a short time.

### BACKGROUND OF THE INVENTION

1. Field of the Invention

The present invention relates to a datagram transmission device that relays datagrams in a communication network.

2. Description of Related Art

In a communication network such as an LAN (local area network) or the Internet, datagrams such as packets are relayed by datagram transmission devices. Known datagram transmission devices include for example routers or switches.

Known technology concerning datagram transmission devices is disclosed for example in the following references.

Reference 1: Laid-open Japanese Patent Publication No. 2000-188608

Reference 2: Laid-open Japanese Patent Publication No. 2000-32056

Reference 3: Laid-open Japanese Patent Publication No. 2000-32003.

In a datagram transmission device, the transmission destination is ascertained using the destination address which belongs the information of the third layer of the protocol (see above Reference 1).

Also, for example a route search algorithm called the dichotomizing search method is employed as a technique for determining the transmission destination from the destination address (see above Reference 1). The dichotomizing search method is a method in which a route is searched for using a map of tree structure constructed by joining large numbers of nodes having a single input and two outputs i.e. pointers. In this method, a node at which the target route entry is mapped is found by following nodes in accordance with whether the subject bit is 1 or 0.

Furthermore, Reference 1 discloses a technique of speeding up the route search using the dichotomizing search method by converting P dichotomizing branch levels into a single tree of 2^{P} branches (hereinbelow, this is termed a “2^{P} search”). With this technique, searching of P branch levels can be performed by a single process, so the time required for the search can be reduced by factor of 1/P.

In recent years, datagram transmission devices have appeared that do not merely transmit datagrams but also control the quality of communication etc of the transmitted datagrams(see the above references 2 and 3). In addition to searching for a route to the transmission destination using the information of the third layer of the protocol, such datagram transmission devices search for optimum communication conditions using the information of the fourth to seventh layers.

In addition, in recent years, datagram transmission devices are being demanded with functions such as a function of determining the priority order of transmission in accordance with the type of datagram (for example the type of application etc) or a function of monitoring datagrams in accordance with prescribed conditions (for example the condition of the transfer origination address etc). In order to realize these functions, searching of the processing conditions using the information of the fourth layer and above is necessary.

However, if a search based on the information of other layers (fourth to seventh layers etc) is simply directly added to the route search based on the information of the third layer, the search processing algorithm becomes extremely complicated. In the case of linear searching using the dichotomizing search method described above, the processing time of the datagram transmission device therefore becomes long.

### SUMMARY OF THE INVENTION

An object of the present invention is to provide a datagram transmission device in which route searching and other searching can be executed at high speed.

Accordingly, in a datagram transmission device according to the present invention, an identification key is generated using information which is stored in a received datagram and is used for transmission control; a transmission control rule corresponding to the identification key is selected from a transmission control rule list; and transmission of the datagram is controlled in accordance with the selected transmission control rule.

With the present invention, the content of transmission control is determined by selection from the list of a transmission control rule corresponding to the identification key, so determination of the content of control can be performed in a short time.

### BRIEF DESCRIPTION OF THE DRAWINGS

Other objects and advantages of the present invention will be described with reference to the hereinafter appended drawings.

FIG. 1 is a block diagram illustrating schematically the functional layout of a major part of a datagram transmission device according to a first embodiment;

FIG. 2A and FIG. 2B are diagrams illustrating the layout of an information table according to a first embodiment;

FIG. 3 is a diagram illustrating the layout of a flow identification key according to a first embodiment;

FIG. 4 is a diagram illustrating the layout of an action table according to a first embodiment;

FIG. 5 is a flowchart given in explanation of the overall operation of a datagram transmission device according to a first embodiment;

FIG. 6 is a block diagram illustrating schematically the functional layout of a major part of a datagram transmission device according to a second embodiment;

FIG. 7 is a diagram illustrating the layout of an information table according to a second embodiment;

FIG. 8 is a flowchart given in explanation of the overall operation of a datagram transmission device according to a second embodiment;

FIG. 9 is a block diagram illustrating schematically the functional layout of a major part of a datagram transmission device according to a third embodiment;

FIG. 10 is a block diagram illustrating schematically the functional layout of a major part of a datagram transmission device according to a fourth embodiment;

FIG. 11 is a diagram illustrating the layout of a conversion table according to a fourth embodiment;

FIG. 12 is a diagram illustrating the layout of a flow identification key according to a fourth embodiment;

FIG. 13 is a diagram illustrating the layout of an action table according to a fourth embodiment;

FIG. 14A, FIG. 14B and FIG. 14C are tables given in explanation of the principles of operation of a datagram transmission device according to a fourth embodiment;

FIG. 15 is a block diagram illustrating schematically the functional layout of a major part of a datagram transmission device according to a fifth embodiment;

FIG. 16 is a diagram illustrating the layout of an information table according to a fifth embodiment; and

FIG. 17 is a block diagram illustrating schematically the functional layout of a major part of a datagram transmission device according to a sixth embodiment.

### DESCRIPTION OF THE PREFERRED EMBODIMENTS

Embodiments of the present invention are described below with reference to the drawings. In the drawings, the size, shape and arrangement relationships of the various constituent components are only shown diagrammatically to a degree such as to enable understanding of the present invention and the numerical value conditions described below are merely by way of example.

First Embodiment

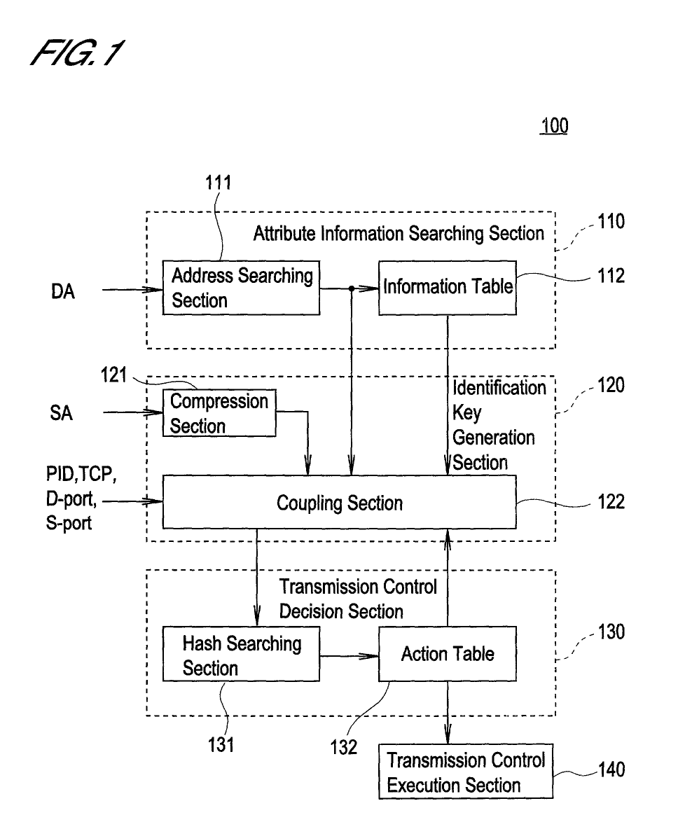

First of all, a datagram transmission device according to a first embodiment of the present invention is described with reference to FIG. 1 to FIG. 5.

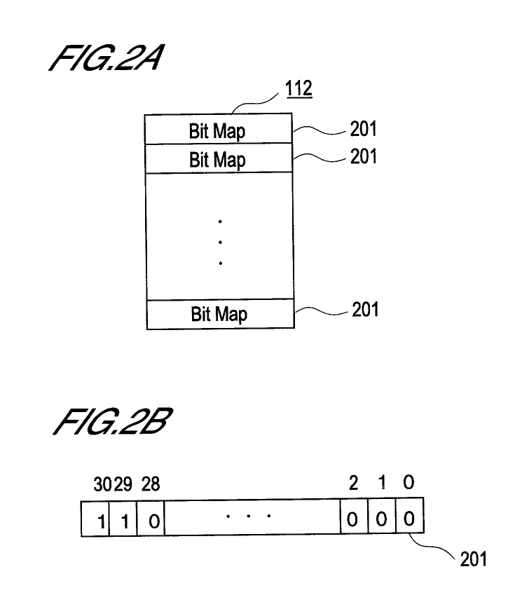

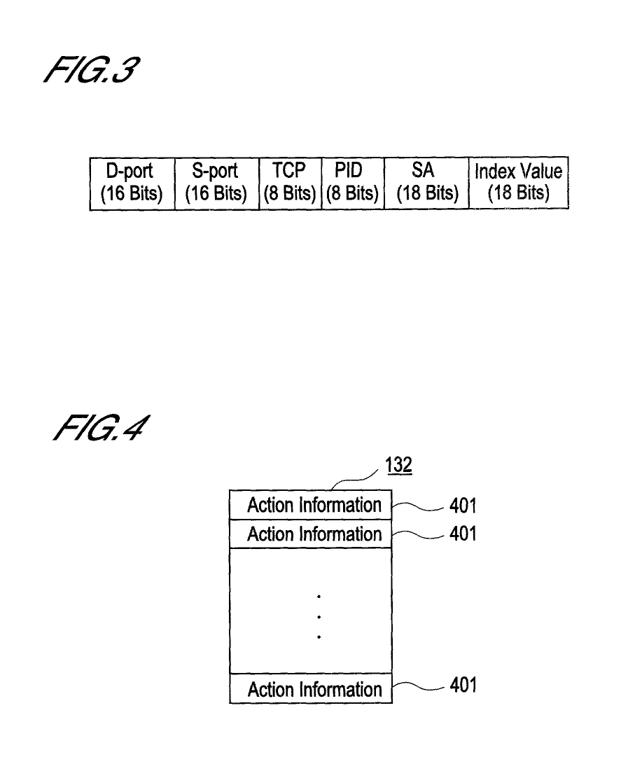

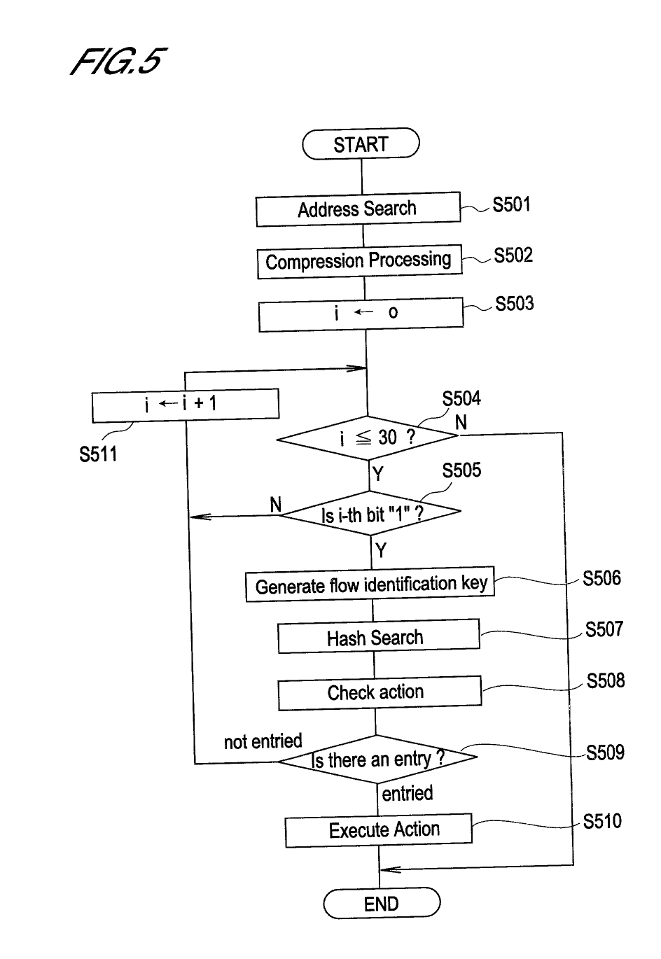

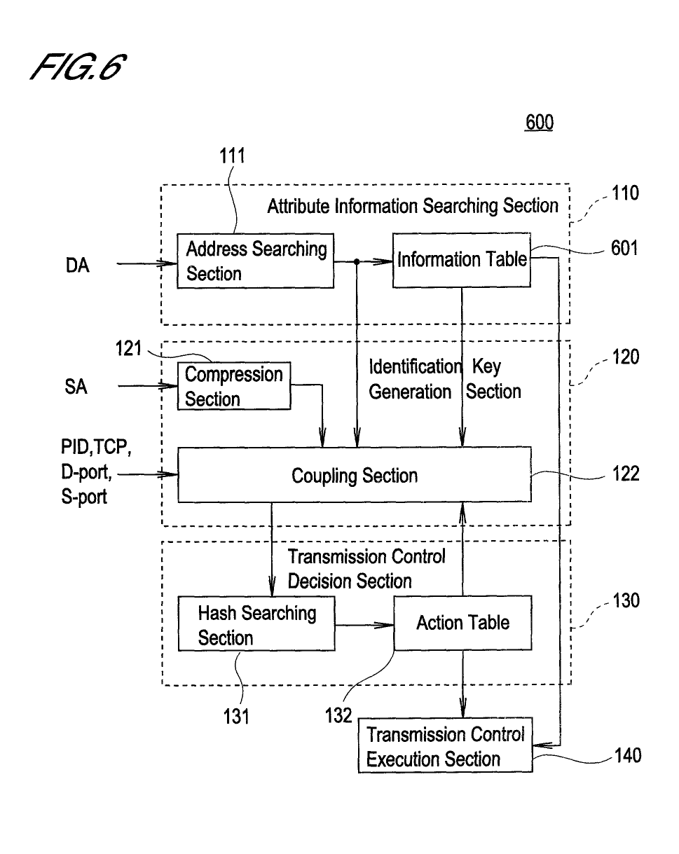

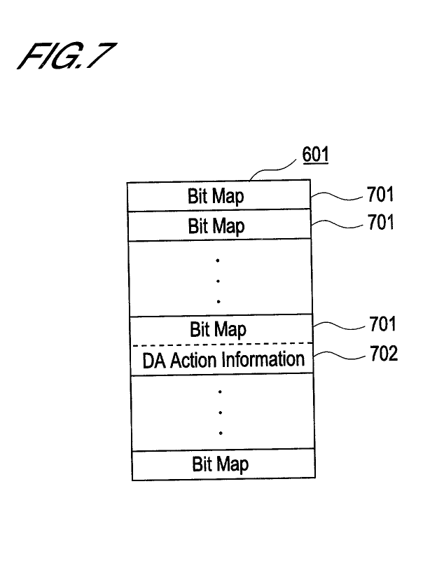

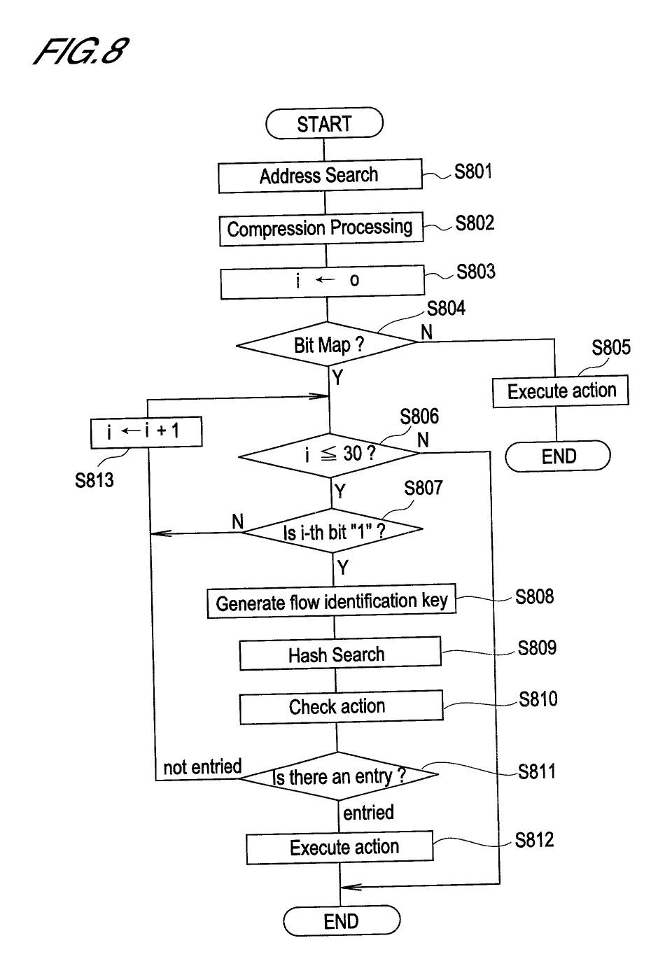

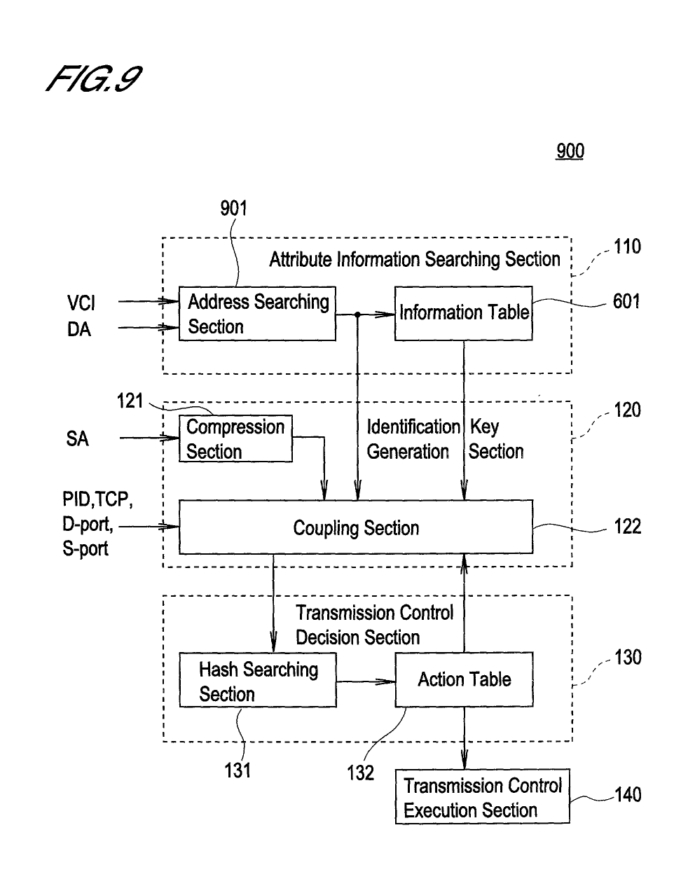

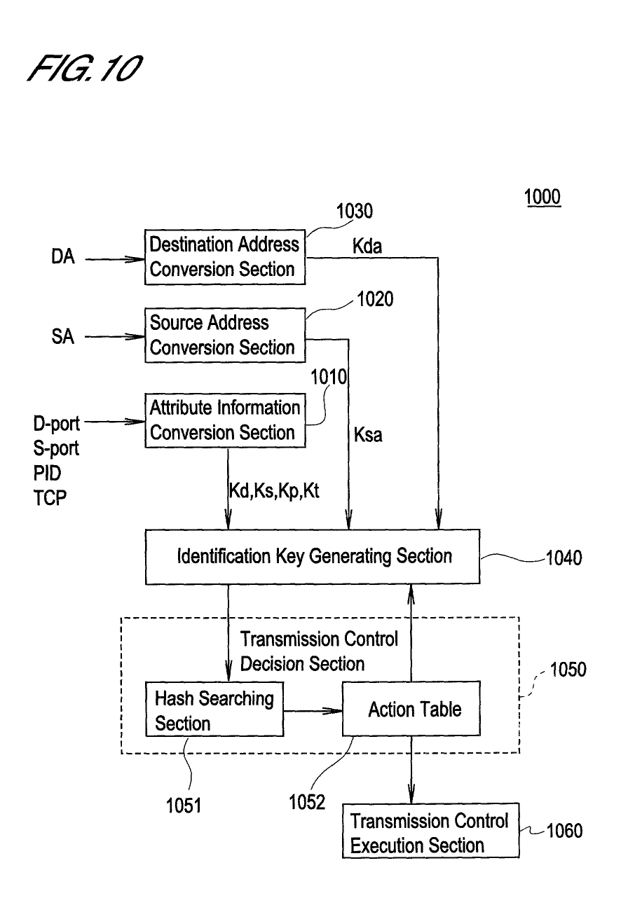

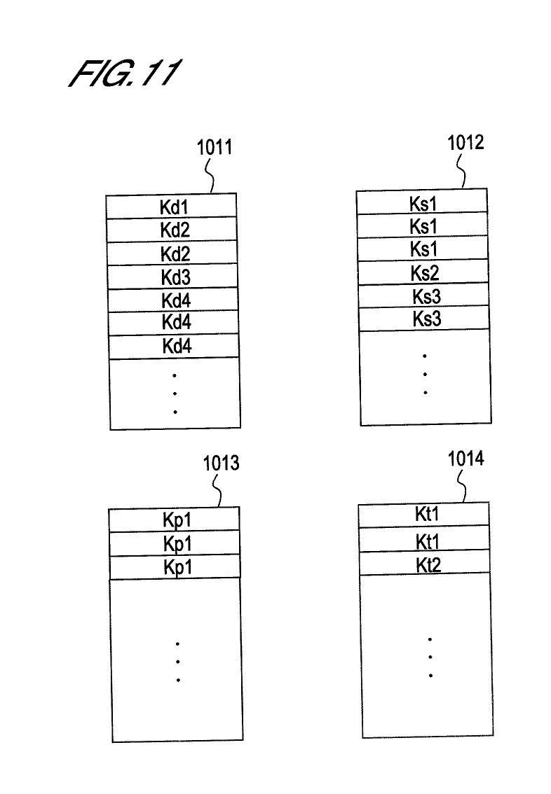

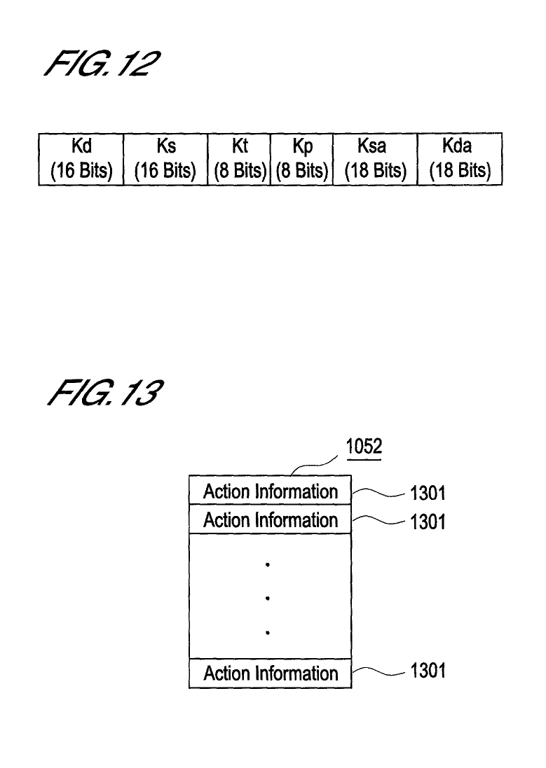

FIG. 1 is a block diagram illustrating diagrammatically the functional layout of a major part of a datagram transmission device according to this embodiment. Also, FIGS. 2A and 2B is a diagram illustrating the layout of an information table, FIG. 3 is a diagram illustrating the layout of a flow identification key and FIG. 4 is a diagram illustrating the layout of an action table.

As shown in FIG. 1, this datagram transmission device 100 comprises an attribute information searching section 110, an identification key generation section 120, a transmission control decision section 130 and a transmission control execution section 140.

Attribute information searching section 110 searches for combinations of attribute information employed in transmission control. This attribute information searching section 110 comprises an address searching section 111 and an information table 112.

Address searching section 111 searches the index of information table 112 using the destination address DA in the received datagram. Any desired algorithm may be employed for search processing but in this embodiment 2^{P} searching described above is employed. The index values selected by searching are sent to identification key generation section 120 and information table 112.

As shown in FIG. 2A, information table 112 stores a large number of bit maps 201. Each bit map 201 respectively indicates a combination of attribute information items employed in transmission control. Any desired type of these attribute information items constituting candidates for use may be employed but usually the attribute information items of the fourth and above layers are employed. In this embodiment, these will be taken to be the transmission source IP address SA, higher rank protocol identifier PID, Transmission Protocol Control flag TCP, transmission source port number S-Port and destination port number D-Port. If one or a plurality of types of these five types of attribute information is employed as the attribute information, the combinations thereof provide 2⁵-1 i.e. 31 types. Each bit map 201 is therefore of 31 bit construction, as shown in FIG. 2B. In FIG. 2B, the upper level is the bit number and the lower level is the bit indicating whether or not the combination in question is deemed to be a candidate for use. In this bit map, the zeroth bit corresponds to the case where the combination of attribute information items consists solely of the source IP address SA, and the 30th bit corresponds to the case where the combination of attribute information items consists of all of the aforementioned five types of attribute information items: SA, PID, TCP, S-Port and D-Port. Of these respective combinations, when the corresponding bit value is “1”, the combination is a candidate and when it is “0” the combination cannot be a candidate. The candidate attribute information items specified in each bit map are not restricted to being only a single one but could be a plurality. in information table 112, the bit map 201 corresponding to the index value that is input from address searching section 111 is sent to identification key generation section 120.

Identification key generation section 120 generates a flow identification key (see FIG. 3). This identification key generation section 120 comprises a compression section 121 and coupling section 122.

Compression section 121 performs compression of the source IP address SA that is extracted from the datagram. In this embodiment, whereas the source IP address SA before compression is 32 bits, the source IP address SA after compression is 18 bits. By means of this compression, the overall length of the flow identification key can be decreased.

Coupling section 122 generates a flow identification key by coupling the attribute information value and index value. As described above, this coupling section 122 receives bit map 201 from information table 112. In addition, coupling section 122 reads the combinations of the attribute information which is corresponding to bit value “1” from this bit map 201. Coupling section 122 then inputs the attribute information value associated with these combinations from outside. The result of the compression performed by compression section 121 is then input as the source IP address SA. In addition, coupling section 122 inputs the index value from address searching section 111, as described above. Coupling section 122 then generates a flow identification key by coupling this attribute information and the index value. The flow identification key that is generated in this way is sent to transmission control determination section 130. In the example of FIG. 3, a flow identification key is generated by using the aforementioned five types of attribute information SA, PID, TCP, S-Port and D-Port. Specifically, in this example, coupling section 122 generates an 84 bit flow identification key by coupling the index value (18 bit), compressed value (18 bit) of the source IP address SA, higher rank protocol identifier PID (8 bit), Transmission Protocol Control flag TCP (8 bit), source port number S-Port (16 bit) and destination port number D-Port (16 bit).

Transmission control decision section 130 determines the content of the action (transmission control) by using the flow identification key. This transmission control decision section 130 comprises a hash searching section 131 and an action table 132.

Hash searching section 131 obtains an index value of action table 132 by performing a hash processing of the flow identification key. The index value obtained by this hash processing is sent to action table 132.

As shown in FIG. 4, action table 132 stores a large number of items of action information 401. Each item of action information 401 respectively indicates the content of the action to be executed, that is searching and setting of transmission routes, transmission, denial of transmission, determination of priority order, and datagram monitoring etc. In action table 132, the action information corresponding to the index value input from hash searching section 131 is sent to transmission control execution section 140.

Transmission control execution section 140 executes the action (transmission control) indicated by the action information that is input from action table 132. In this action, searching and setting of transmission routes, transmission, denial of transmission, determination of priority order, and datagram monitoring etc are performed in accordance with the selected transmission control rule.

Next, the overall operation of a datagram transmission device according to this embodiment is described with reference to the flowchart of FIG. 5.

First of all, address searching section 111 executes searching by using the destination address DA (see S501). As described above, the index value obtained by this searching is sent to information table 112 and information table 112 sends the bit map corresponding to this index value to coupling section 122.

Next, compression section 121 performs compression of the source IP address SA that is stored in the datagram (see S502). The compressed source IP address SA is sent to coupling section 122.

Next, coupling section 122 substitutes “0” in the variable i indicating the bit number of the bit map (S503). This variable i is then compared with the maximum value “30” of the bit number (see S504). If variable i is greater than “30”, it is concluded that processing has been completed in respect of all of the bit numbers, and operation is terminated. On the other hand, if the variable i is not greater than “30”, the value of the i-th bit is read from the bit map that was input from information table 112, and a determination is made as to whether this value is “0” or “1” (see S505). As described above, if the i-th bit value is “0”, the combination of attribute information items corresponding to this bit cannot constitute a candidate for transmission control. Consequently, if the i-th bit is “0”, coupling section 122 again executes the step S504 and subsequent steps after substituting i+1 in variable i (see S511). On the other hand, if the i-th bit is “1”, the combination of attribute information items corresponding to this bit is a candidate for transmission control. Coupling section 122 therefore generates a flow identification key corresponding to this combination (see S506). This flow identification key is sent to hash searching section 131.

Hash searching section 131 executes hash searching as described above (see S507) and sends the search result (index value) to action table 132. Action table 132 checks whether or not an action exists corresponding to this index value (see S508). If there is no entry in respect of the corresponding action (see S509), it communicates this fact to coupling section 122 and coupling section 122 substitutes i+1 for the variable i (see S511) and then again executes step S504 and the subsequent steps. On the other hand, if, in step S509, it is found that there is an entry for the corresponding action, action table 132 sends the information indicating this action to transmission control execution section 140. Transmission control execution section 140 then executes the action corresponding to the received information (see S510).

In the example of FIG. 5, generation of the flow identification key was taken to be performed only in the case where variable i is “1” (see S505 and S506). However, it could be arranged to select the flow identification key to be employed by checking the variable i after generating all of the flow identification keys.

As described above, in this embodiment, it is arranged for the combinations of attribute information employed in transmission control to be searched, a flow identification key to be generated in accordance with this search result, and the content of the transmission control to be executed to be determined using this thus-generated key. Transmission control can therefore be executed at high speed.

Second embodiment Next, a second embodiment of the present invention is described with reference to FIG. 6 to FIG. 8.

FIG. 6 is a block diagram illustrating schematically the functional layout of a major part of a datagram transmission device 600 according to this embodiment. In FIG. 6, structural elements given the same reference symbols as in FIG. 1 respectively indicate items that are identical with those of FIG. 1. Also, FIG. 7 is a diagram illustrating the layout of an information table.

The layout of the information table in this embodiment differs from that of the first embodiment described above.

In information table 601, as shown in FIG. 7, a large number of bit maps 701 are stored in correspondence with indexes. The indexes are searched by index searching section 111 in the same way as in the first embodiment. Also, in this embodiment, in respect of some of the indexes, DA action information 702 is stored in addition to bit map 701.

Each bit map 701 indicates the combination of items of attribute information employed in transmission control in the same way as in the first embodiment. The number of combinations is 31. In the same way as in the first embodiment, the candidate items of attribute information are the source IP address SA, the higher rank protocol identifier PID, Transmission Protocol Control flag TCP, source port number S-Port and destination port number D-Port.

In DA action information 702 there is stored the action information, for example the transmission route information, in the case of performance of transmission control using only destination address DA. As this DA action information 702, rather than storing information corresponding to all of the indexes, information is only stored at indexes corresponding to cases where the action is determined solely by the destination address DA.

In the first embodiment described above, even when only transmission using the destination address is to be performed, datagram transmission device 100 was arranged such as to perform hash searching by generating a flow identification key. However, when only transmission using a destination address is to be performed, hash searching taking into account the other attribute information is unnecessary. Consequently, in cases where it is decided that the action to be performed consists solely of transmission, transmission processing can be further speeded up by arranging to immediately execute transmission, without performing generation of a flow identification key or hash searching.

Next, the overall operation of datagram transmission device according to this embodiment will be described using the flowchart of FIG. 8.

First of all, attribute information searching section 110 performs a search based on the destination address DA (see S801). In this search, address searching section 111 first of all searches the indexes using the destination address DA. The index value obtained by this search is sent to information table 601. Information table 601 first of all checks whether or not DA action information 702 is stored in the storage region corresponding to this index value. If DA action information 702 is stored therein, it then sends this DA action information 702 to coupling section 122. On the other hand, if DA action information 702 is not stored therein, information table 601 sends to coupling section 122 bit map 701 corresponding to this index.

Next, compression section 121 performs compression of the source IP address SA in the datagram (see S802). The source IP address SA after compression is sent to coupling section 122. It should be noted that this compression processing could be performed after ascertaining the information that is input to coupling section 122 is a bit map 701, in step S804 described below.

Next, coupling section 122 substitutes “0” in variable i indicating the bit number of the bit map (see S803).

Next, coupling section 122 ascertains whether the information that is input thereto from information table 601 is bit map 701 or is DA action information 702 (see S804). If it is DA action information 702, the coupling section sends this DA action information 702 to transmission control execution section 140. Transmission control execution section 140 then executes the action in accordance with this DA action information 702 (see S805).

On the other hand, if, in step S804, it is concluded that the information is bit map 701, coupling section 122 compares this variable i with the maximum value “30” of the bit number (see S806). If variable i is larger than “30”, it is concluded that processing in respect of all the bit numbers has been completed and operation is terminated. On the other hand, if the variable i is no more than “30”, the bit value of the i-th bit is read from the bit map input from information table 601, and whether this value is “0” or “1” is evaluated (see S807). As mentioned above, if the value of the i-th bit is “0”, the combination of items of attribute information corresponding to this bit cannot constitute a candidate for transmission control. Consequently, if the i-th bit is “0”, coupling section 122 substitutes i+1 in variable i (see S813) and then again executes step S806 and the subsequent steps. On the other hand, if the i-th bit is “1”, the combination of the attribute information items corresponding to this bit is a candidate for transmission control, so coupling section 122 generates a flow identification key corresponding to this combination (see S808). This flow identification key is sent to hash searching section 131.

Hash searching section 131 executes hash searching as described above (see S809) and sends the index value obtained as a result of this searching to action table 132. Action table 132 checks to ascertain whether or not there is an action corresponding to this index value (see S810); if there is no corresponding action (see S811), it communicates this fact to coupling section 122. On receipt of this communication, coupling section 122 substitutes i+1 in variable i (see S813) and then again executes step S806 and the subsequent steps. On the other hand, if there is a corresponding action (see S811), action table 132 sends the information indicating this action to transmission control execution section 140. Transmission control execution section 140 executes the action corresponding to this received information (see S812).

In the example of FIG. 8, it was assumed that a flow identification key was only generated if variable i is “1”. However, it would be possible to select a flow identification key to be used by checking variable i after generating all the flow identification keys.

In this embodiment, it was arranged that the flow identification key and hash searching were not performed when transmission control is performed using only the destination address DA. Consequently, transmission control can be performed at even higher speed than in the case of the first embodiment.

If attribute information other than the destination address DA is also employed, high-speed transmission control is achieved in the same way as in the case of the first embodiment.

Third Embodiment

Next, a third embodiment of the present invention is described with reference to FIG. 9.

FIG. 9 is a block diagram illustrating schematically the functional layout of a major part of a datagram transmission device 900 according to this embodiment. In FIG. 9, structural elements having the same reference symbols as in FIG. 1 and FIG. 6 indicate items which are respectively the same as in these Figures.

In this embodiment, the construction of the address searching section is different from that in the second embodiment described above.

Address searching section 901 searches the indexes of information table 601 using the destination address DA and VCI (virtual channel identifier) in the received datagram. Any desired algorithm may be employed for search processing but in this embodiment it is assumed that the 2^{P} searching described above is employed. The index value selected by the search is sent to identification key generation section 120 and information table 601.

In the first and second embodiments described above, only the destination address DA was assumed to be employed in the address search. However, in current communication networks, transmission processing employing the attribute information of the second layer is still utilized. In this embodiment, it is possible to find a transmission route since address searching section 901 is constituted so as to perform an address search taking into account virtual channel and destination address and DA action information 702 is stored in information table 601. In the same way as in the case of the second embodiment described above, transmission processing can be performed using the attribute information of the second layer.

It should be noted that a VCI is a channel that is employed when the second layer is ATM (Asynchronous Transfer Mode). In the case where the second layer is of another transmission mode, information corresponding to this transmission mode is employed for address searching.

The rest of the construction and operation of datagram transmission device 900 according to this embodiment is the same as in the case of the second embodiment described above, so description thereof is omitted.

As described above, in this embodiment, a datagram transmission device according to this invention can be employed in a communication network in which transmission processing is performed using the attribute information of the second layer.

Fourth embodiment

A datagram transmission device according to a fourth embodiment of the present invention is described with reference to FIG. 10 to FIG. 14.

FIG. 10 is a block diagram illustrating schematically the functional layout of a major part of a datagram transmission device according to this embodiment.

As shown in FIG. 10, this datagram transmission device 1000 comprises an attribute information conversion section 1010, source address conversion section 1020, destination address conversion section 1030, identification key generation section 1040, transmission control decision section 1050, and transmission control execution section 1060.

Attribute information conversion section 1010 respectively converts the attribute information extracted from the datagram into index values. In this embodiment, it will be assumed that, as the attribute information, the higher rank protocol identifier PID (8 bits), Transmission Protocol Control flag TCP (8 bits), source port number S-Port (16 bits) and destination port number D-Port (16 bits) are selected. This attribute information conversion section 1010 comprises four conversion tables 1011 to 1014 (see FIG. 11). In conversion table 1011, there is stored a value of the index value Kd corresponding to each value of the destination port number D-Port. In conversion table 1012, there is stored a value of index value Ks corresponding to each value of the source port number S-Port. Also, in conversion table 1013, there is stored a value of the index value Kp corresponding to each value of the higher rank protocol identifier PID. Likewise, in conversion table 1014, there is stored a value of the corresponding index value Kt for each value of the Transmission Protocol Control flag TCP. Attribute information conversion section 1010 extracts the various items of identification information D-Port, S-Port, PID and TCP from the received datagram (for example packet) and outputs the index values Kd, Ks, Kp and Kt of the values corresponding to the values of the respective items of identification information. It should be noted that, in this embodiment, the bit lengths of the index values Kd, Ks, Kp and Kt are the same as the bit lengths of the corresponding items of attribute information D-Port, S-Port, PID, and TCP i.e. 16 bits, 16 bits, 8 bits, and 8 bits (see FIG. 12 described below).

Source address conversion section 1020 converts the source IP address SA that is extracted from the datagram into an index value Ksa. Any desired conversion method may be employed for converting the source IP address SA. For example, the value obtained by compression of the source IP address SA may be taken as index value Ksa, and the index value Ksa may be searched using the dichotomizing search method or 2^{P} branch method.

Destination address conversion section 1030 converts the destination IP address DA extracted from the datagram into an index value Kda. Any desired conversion method for converting a destination IP address DA may be employed. For example, the index value Kda may be searched using the dichotomizing search method or 2^{P} branch method.

Identification key generation section 1040 generates a flow identification key (see FIG. 12) by coupling the index values Kd, Ks, Kt, Kp, Ksa and Ksd received from respective conversion sections 1010, 1020, 1030. This flow identification key that has thus been generated is sent to transmission control decision section 1050.

Transmission control decision section 1050 determines the action i.e. the content of transmission control using the flow identification key. This transmission control decision section 1050 comprises a hash searching section 1051 and action table 1052.

Hash searching section 1051 obtains an index value of action table 1052 by hash processing using the flow identification key. The index value obtained by hash processing is sent to action table 1052.

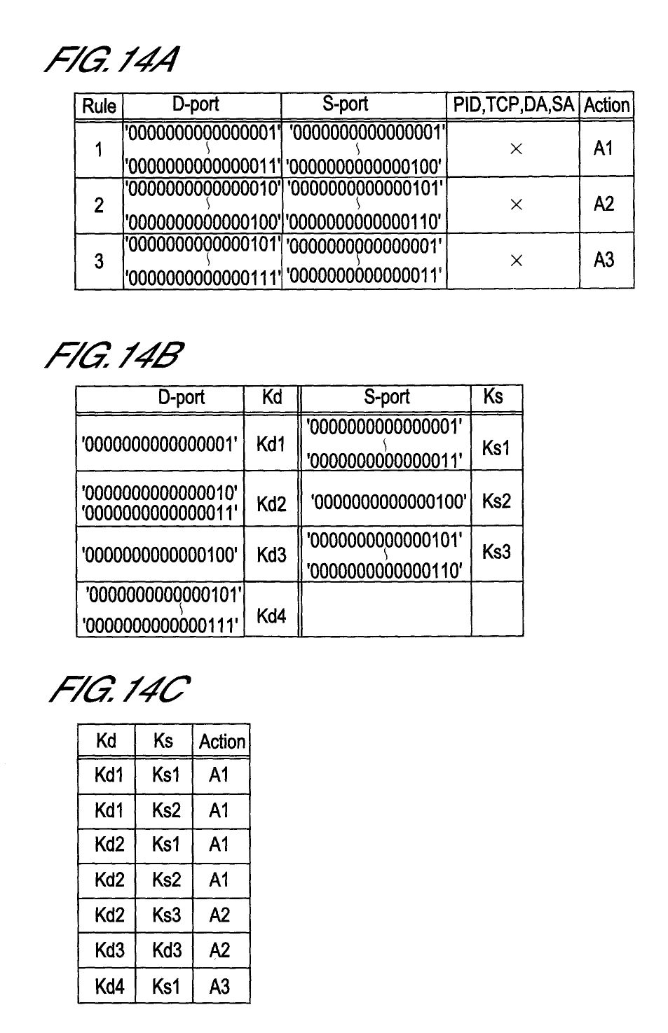

Action table 1052, as shown in FIG. 13, stores a large number of items of action information 1301. The items of action information 1301 respectively indicate the content of the action to be performed, that is, search and setting of transmission route, transmission, denial of transmission, determination of priority order and monitoring of datagram etc. Action table 1052 sends to transmission control execution section 1060 the action information corresponding to the index value that is input from hash searching section 1051.

Transmission control execution section 1060 executes action (transmission control) indicated by the action information input from action table 1052. In this action, search and setting of transmission route, transmission, denial of transmission, determination of priority order and monitoring of datagram etc are performed in accordance with the selected transmission control rule.

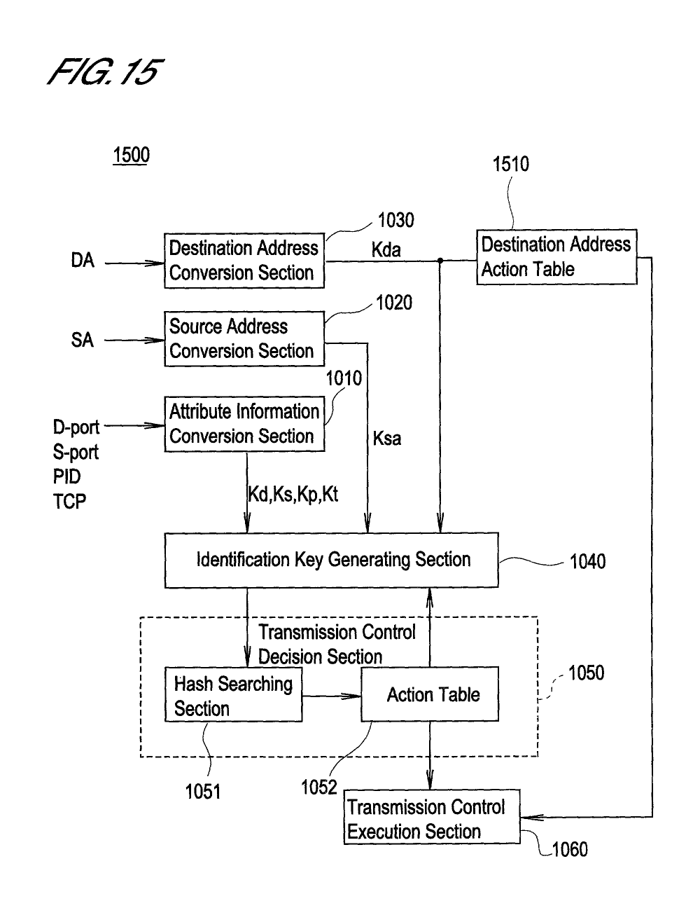

Next, the principles of operation of datagram transmission device 1000 according to this embodiment are described with reference to FIG. 14.

FIG. 14A illustrates an example of transmission control performed by datagram transmission device 1000. Specifically, FIG. 14A implies that when the value of the destination port number D-Port in the received datagram is “0000000000000001” to “0000000000000011” and the value of the source port number S-Port is “0000000000000001” to “0000000000000100”, action A1 is executed irrespective of the values of the other items of information PID, TCP, SA and DA; when the value of the destination port number D-Port in the received datagram is “0000000000000010” to “0000000000000100” and the value of the source port number S-Port is “0000000000000101” to “0000000000000110”, action A2 is executed irrespective of the values of the other items of information PID, TCP, SA and DA; and when the value of the destination port number D-Port in the received datagram is “0000000000000101” to “0000000000000111” and the value of the source port number S-Port is “0000000000000001” to “0000000000000011”, action A3 is executed irrespective of the values of the other items of information PID, TCP, SA and DA.

When it is desired to execute action i.e. transmission control with such a rule, the index values Kd, Ks corresponding to the attribute information items D-Port, S-Port may be set as in FIG. 14B. Specifically, the index value corresponding to the case where the destination port number D-Port is “0000000000000001” is taken as Kd1, the index value when the destination port number D-Port is “0000000000000010” or “0000000000000011” is taken as Kd2, the index value corresponding to the case where the destination port number D-Port is “0000000000000100” is taken as Kd3, and the index value when the destination port number D-Port is “0000000000000101” to “000000000000111” is taken as Kd4. Furthermore, the index value corresponding to the case where the source port number S-Port is “0000000000000001” to “0000000000000011” is taken as being Ks1, the index number corresponding to the case where the source port number S-Port is “0000000000000100” is taken as being Ks2, and the index value corresponding to the case where the destination port number D-Port is “0000000000000101” or “0000000000000110” is taken as Kd3. It should be noted that, since the other items of information SA, DA, PID and TCP are not taken into account, the index values Ksa, Ksd, Kt and Kp corresponding to these items of information SA, DA, PID and TCP may be applied (or may be determined in accordance with another rule). The index values stored in conversion table as 1011 to 1014 are therefore for example as shown in FIG. 11. By setting the storage contents of conversion tables 1011 to 1014 as in FIG. 11, the attribute information can be converted into index values by a rule as shown in FIG. 14B.

The rule for the hash search performed by transmission control decision section 1050 may be determined as in FIG. 14C. Specifically, the stored values of action table 1052 are determined such that the result of the hash search when the index values (Kd, Ks) corresponding to attribute information items D-Port, S-Port are (Kd1, Ks1), (Kd1, Ks2), (Kd2, Ks1) or (Kd2, Ks2) is action A1, the result of the hash search when the index values (Kd, Ks) are (Kd2, Ks3) or (Kd3, Ks3) is action A2 and the result of the hash search when the index values (Kd, Ks) are (Kd4, Ks1) is action A3.

By determining the stored values of conversion tables 1011 to 1014 and action table 1052 in this way, the content of the transmission control can be determined by a rule as shown in FIG. 14A.

As described above, with this embodiment, when determining transmission control, instead of carrying out a search directly employing all the items of information (in the example described above, the higher rank protocol identifier PID, Transmission Protocol Control flag TCP, source Port number S-Port, destination port number D-Port, source IP address SA and destination IP address DA), a flow identification key was generated by converting these items of information individually into index values, and performing the search using this flow identification key. Consequently, transmission control can be executed at high speed, since determination of the content of control can be performed at higher speed than first to third embodiments described above.

Furthermore, according to this embodiment, the number of types of rule stored in the action table can be compressed, so the memory capacity of the datagram transmission device can be made small.

Fifth embodiment

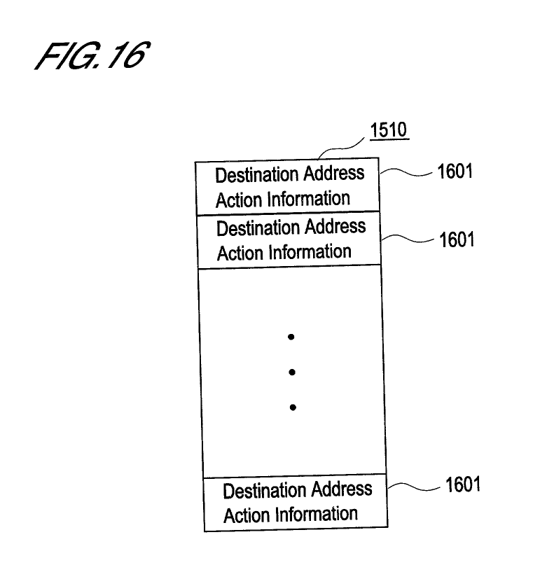

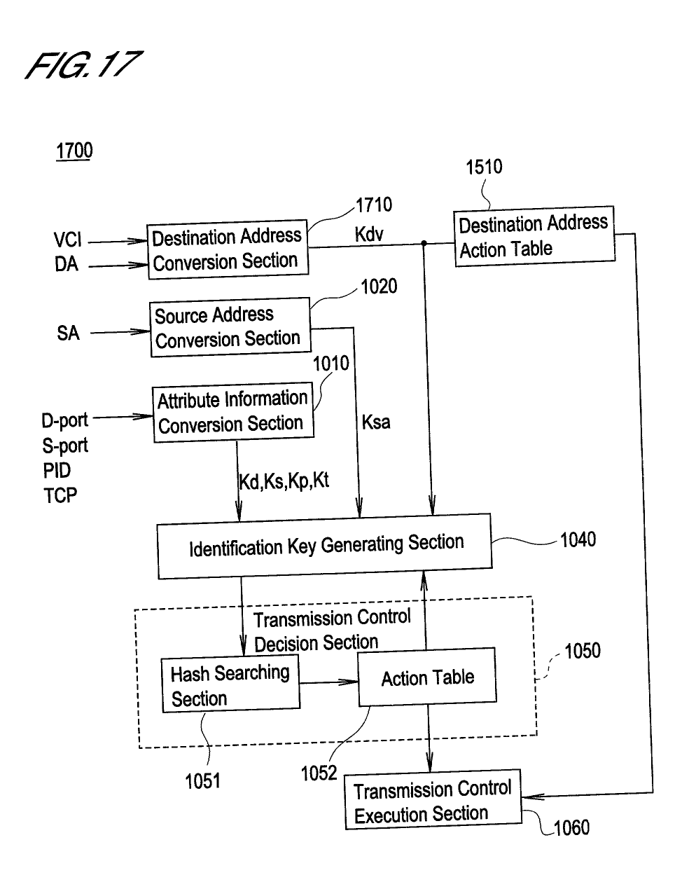

Next, a fifth embodiment of the present invention is described with reference to FIG. 15 and FIG. 16.

A datagram transmission device accordance this embodiment comprises an action table for the destination address.

FIG. 15 is a block diagram illustrating schematically the functional layout of a major part of a datagram transmission device 1500 according to this embodiment. In FIG. 15, constructional elements given the same reference symbols as in FIG. 10 indicate identical items to those in the case of FIG. 10, respectively. Also, FIG. 16 is a diagram illustrating the layout of a destination address action table 1510.

As shown in FIG. 16, destination address action information 1601 is stored in destination address action table 1510.

Destination address action information 1601 is action information, for example transmission route information, in the case where transmission control is performed using only the destination address DA.

In the fourth embodiment described above, the datagram transmission device 1000 was constructed such that hash searching was formed by generating a flow identification key even in the case where only transmission based on the destination address was desired to be performed. However, where only transmission using the destination address is performed, hash searching taking into account the source address or attribute information is unnecessary. Consequently, when it is concluded that the action consists solely of transmission, transmission processing can be further speeded up by immediately executing transmission without performing flow identification key generation or hash searching.

In a datagram transmission device 1500 according to this embodiment, when a datagram is received, first of all, destination address conversion section 1030 converts destination address DA and outputs an index value Kda. This index value Kda is sent to identification key generation section 1040 and is also sent to destination address action table 1510. Destination address action table 1510 checks to ascertain whether destination address action information 1601 is stored in a storage region corresponding to this index value Kda or not. If destination address action information 1601 is stored, this destination address action information 1601 is sent to transmission control execution section 1060. On the other hand, if destination address action information 1601 corresponding to this index value Kda is not stored, destination address action table 1510 does not output action information.

When transmission control execution section 1060 has received action information 1601 from destination address action table 1510, it performs transmission processing in accordance with this action information. On the other hand, if action information 1601 has not been received from destination address action table 1510, it performs transmission processing in accordance with the action information received from action table 1052 of transmission control decision section 1050 in the same way as in the case of the fourth embodiment.

In this way, according to this embodiment, when transmission control is performed using only the destination address DA, it is arranged that the action information is determined without performing flow identification key generation or hash searching, so transmission control can be further speeded up compared with the case of the fourth embodiment.

Sixth Embodiment

Next, a sixth embodiment of the present invention is described with reference to FIG. 17.

FIG. 17 is a block diagram illustrating schematically the functional layout of a major part of a datagram transmission device 1700 according to this embodiment. In FIG. 17, constructional elements given the same reference symbols as in FIG. 10 and FIG. 15 respectively indicate items which are identical with these Figures.

In this embodiment, the arrangement of the destination address conversion section is different from that of the fifth embodiment described above.

Destination address conversion section 1710 converts the combination of destination address DA and virtual channel identifier VCI in the received datagram to an index value Kdv. Any desired method of conversion may be employed for the destination address conversion section 1710. For example, index values Kdv could be searched using a dichotomizing search method or the like.

This index value Kdv is sent to identification key generation section 1040 and is also sent to destination address action table 1510. Destination address action table 1510 checks to ascertain whether or not destination address action information 1601 is stored in a storage region corresponding to this index value Kdv. Then, if destination address action information 1601 is stored therein, it sends this destination address action information 1601 to transmission control execution section 1060. On the other hand, if no destination address action information 1601 corresponding to this index value Kdv is stored, destination address action table 1510 does not output action information.

In the same way as in the case of the fifth embodiment, if transmission control execution section 1060 receives action information 1601 from destination address action table 1510, it performs transmission control in accordance with this action information but if action information 1601 is not received from the destination address action table 1510, it performs transmission control in accordance with action information received from action table 1052 of transmission control decision section 1050.

The rest of the construction and operation of datagram transmission device 1700 according to this embodiment is the same as in the case of the fifth embodiment described above, so description thereof is omitted.

In this way, according to this embodiment, a datagram transmission device according to the present invention can be applied to a communication network wherein transmission processing is performed using attribute information of the second layer such as VCI.

As described in detail above, according to the present invention, there can be provided a datagram transmission device whereby transmission control can be performed at high speed and the required memory capacity is small.

What is claimed is:

1. A datagram transmission device wherein;
an identification key is generated using information which is stored in a received datagram and is used for transmission control;
a transmission control rule corresponding to said identification key is selected from a transmission control rule list;
and transmission of said datagram is controlled in accordance with the selected transmission control rule.

2. The datagram transmission device according to claim 1 comprising:
attribute information searching means that searches combinations of attribute information employed for transmission control using the destination address of the received datagram;
identification key generation means that reads from said datagram said attribute information contained in the search result of said attribute information searching means and generates said identification key corresponding to the value of said attribute information that has been read;
transmission control decision means that selects on a transmission control rule using said identification key generated by said identification key generation means; and
transmission control execution means that controls transmission in accordance with a transmission control rule selected by said transmission control decision means.

3. The datagram transmission device according to claim 2 wherein said attribute information searching means comprises:
an information table that stores information indicating combinations of said attribute information; and
address searching means that searches the indexes of said information table using said destination address.

4. The datagram transmission device according to claim 3 wherein said identification key generation means generates said identification key including said index obtained by the searching of said address searching means.

5. The datagram transmission device according to claim 2 wherein said identification key generation means generates said identification key using a compressed value of the value of said attribute information of one or more types.

6. The datagram transmission device according to claim 2 wherein said transmission control decision means comprises:
an action table that stores a plurality of types of execution content of said transmission control; and
hash searching means that searches the indexes of said action table by hash searching using said identification key.

7. The datagram transmission device according to claim 3 wherein said information table stores destination address execution information that indicates the execution content when said transmission control is only transmission; and
said transmission control execution means executes said transmission when said destination address execution information has been input.

8. The datagram transmission device according to claim 2 wherein said attribute information of at least one or more types is information belonging to the fourth layer or a layer thereabove of the protocol.

9. The datagram transmission device according to claim 2 wherein said attribute information searching means searches combinations of said attribute information using information belonging to the second layer of the protocol and said destination address.

10. The datagram transmission device according to claim 9 wherein said information belonging to the second layer of the protocol is an virtual channel identifier of the asynchronous transfer mode.

11. The datagram transmission device according to claim 1 comprising:
attribute information conversion means that reads attribute information of one or a plurality of types from a received datagram, individually determines an index value corresponding to the value of these items of attribute information and outputs one or a plurality of said index values obtained by said determination as respective conversion results;
identification key generation means that generates an identification key including said index value input from said attribute information conversion means;
transmission control decision means that decides on the execution content of transmission control using said identification key generated by said identification key generation means; and
transmission control execution means that executes transmission control decided upon by said transmission control decision means.

12. The datagram transmission device according to claim 11 wherein said attribute information conversion means comprises a conversion table that stores the correspondence relationship of the values of said attribute information and said index values, for each type of said attribute information.

13. The datagram transmission device according to claim 11 wherein said transmission control decision means comprises:
an action table that stores a plurality of types of execution content of said transmission control; and
hash searching means that searches the indexes of said action table by hash searching using said identification key.

14. The datagram transmission device according to claim 11 further comprising source address conversion means that converts the source address read from a received datagram into an index value by a prescribed method and sends this to said identification key generation means; and
said identification key generation means generates said identification key including said index value input from said source address conversion means.

15. The datagram transmission device according to claim 11 further comprising destination address conversion means that converts the destination address read from a received datagram into an index value by a prescribed method and sends this to said identification key generation means; and
said identification key generation means generates said identification key including said index value input from said destination address conversion means.

16. The datagram transmission device according to claim 15 wherein;
said destination address conversion means determines whether or not said destination address corresponds to a destination address in respect of which, as transmission control, only transmission is performed, and, if it corresponds, outputs transmission execution information to said transmission control execution means; and
said transmission control execution means execute transmission control using said transmission execution information in the case of said transmission control execution means input said transmission execution information.

17. The datagram transmission device according to claim 15 wherein said destination address conversion means converts a combination of information belonging to the second layer of the protocol and said destination address to said index value.

18. The datagram transmission device according to claim 17 wherein said information belonging to the second layer of the protocol is an virtual channel identifier of the asynchronous transfer mode.

19. The datagram transmission device according to claim 1 wherein said datagram transmission device is an Internet protocol router.

20. The datagram transmission device according to claim 1 wherein said datagram transmission device is an Internet protocol switch.
